(19) United States
(12) Patent Application Publication
(10) Pub. No.: US 2024/0375336 A1
(43) Pub. Date: Nov. 14, 2024

(54) PLASTIC OPTICAL FIBER MANUFACTURING METHOD AND PLASTIC OPTICAL FIBER MANUFACTURING APPARATUS

(71) Applicant: NITTO DENKO CORPORATION, Ibaraki-shi, Osaka (JP)

(72) Inventors: Tatsuya Araki, Osaka (JP); Kenichiro Nishiwaki, Osaka (JP); Sho Irie, Osaka (JP); Yasuharu Imamura, Osaka (JP)

(73) Assignee: NITTO DENKO CORPORATION, Ibaraki-shi, Osaka (JP)

(21) Appl. No.: 18/580,699

(22) PCT Filed: Jul. 20, 2022
(86) PCT No.: PCT/JP2022/028275

§ 371 Date: Jan. 19, 2024

(30) Foreign Application Priority Data
Jul. 21, 2021 (JP) 2021-121067

(51) Int. Cl. B29C 48/21; B29C 48/05; B29C 48/285; B29L 11/00

(52) U.S. Cl. CPC B29C 48/21; B29C 48/05; B29C 48/288; B29L 2011/0075

(57) ABSTRACT

A method is disclosed for manufacturing a plastic optical fiber composed of a plurality of layers including a core and a cladding, which includes forming at least one layer formed of the plurality of layers by melt extrusion molding of a material resin using a melt extrusion unit including an extrusion screw, wherein a pellet of the material resin is fed to the melt extrusion unit, and a relation expressed by the following inequality (I) is satisfied by a flight height H_{f} (mm) of the extrusion screw in a feed zone L_{f} of the melt extrusion unit and a maximum dimension Lₘₐₓ (mm) of the pellet to be fed: 0≤H_{f}−Lₘₐₓ≤3 (I); and a volume V (mm³) of the pellet satisfies the following inequality (II): 4<V<25. The manufacturing method is suitable for further improvement of the quality of plastic optical fibers.

### TECHNICAL FIELD

The present invention relates to a plastic optical fiber manufacturing method and a plastic optical fiber manufacturing apparatus.

### BACKGROUND ART

Optical fibers include plastic optical fibers (hereinafter referred to as POFs). POFs are excellent in flexibility and processability compared to quartz glass optical fibers, and can be manufactured at low cost. POFs are chiefly used as transmission media for short-distance (e.g., 100 m or shorter) use. A POF is composed of a plurality of layers including a core and a cladding. The core is a layer positioned in the center of the optical fiber and is responsible for transmission of light. The cladding is a layer disposed on an outer surface of the core with respect to the central axis of the optical fiber to coat the core. The core has a relatively high refractive index, while the cladding has a relatively low refractive index. A coating layer coating the outer circumference of the cladding may be disposed in some cases.

POFs can be manufactured, for example, by a melt spinning method. According to the melt spinning method, each of layers included in an optical fiber is formed by melt extrusion molding of a material resin. Patent Literature 1 discloses a melt extrusion apparatus including an extrusion screw and a POF manufacturing method using the apparatus. Patent Literature 2 discloses a gas-pressure melt extrusion apparatus and a POF manufacturing method using the apparatus.

### CITATION LIST

### Patent Literature

Patent Literature 1: JP 2000-356716 A

Patent Literature 2: U.S. Pat. No. 6,527,986 B2

### SUMMARY OF INVENTION

### Technical Problem

Further improvement of the quality of information transmission materials, including POFs, is recently required because of increase in information transmission speed. The present invention aims to provide a technique suitable for further improvement of the quality of POFs.

### Solution to Problem

The present invention provides a method for manufacturing a POF composed of a plurality of layers including a core and a cladding, the manufacturing method including
forming at least one layer formed of the plurality of layers by melt extrusion molding of a material resin using a melt extrusion unit including an extrusion screw, wherein
a pellet of the material resin is fed to the melt extrusion unit, and
a relation expressed by the following inequality (I) is satisfied by a flight height H_{f} (unit: mm) of the extrusion screw in a feed zone of the melt extrusion unit and a maximum dimension Lₘₐₓ (unit: mm) of the pellet to be fed:

$$0 \leq {H}_{f} - {L}_{max} \leq 3 ; \qquad ( I )$$

and
a volume V (unit: mm³) of the pellet satisfies the following inequality (II):

$$4 < V < 25. \qquad ( II )$$

In another aspect, the present invention provides an apparatus for manufacturing a POF composed of a plurality of layers including a core and a cladding, the manufacturing apparatus including
a melt extrusion unit that forms at least one layer selected from the plurality of layers by melt extrusion molding of a pellet of a material resin, wherein
the melt extrusion unit includes an extrusion screw,
a relation expressed by the following inequality (I) is satisfied by a flight height H_{f} (unit: mm) of the extrusion screw in a feed zone of the melt extrusion unit and a maximum dimension Lₘₐₓ (unit: mm) of the pellet to be fed to the melt extrusion unit:

$$0 \leq {H}_{f} - {L}_{max} \leq 3 ; \qquad ( I )$$

and
a volume V (unit: mm³) of the pellet satisfies the following inequality (II):

$$4 < V < 25. \qquad ( II )$$

### Advantageous Effects of Invention

The technique of the present invention is suitable for further improvement of the quality of POFs.

### BRIEF DESCRIPTION OF DRAWINGS

FIG. 1 is a schematic diagram showing an example of a manufacturing apparatus that can be used for the manufacturing method of the present invention.

FIG. 2 is a cross-sectional view schematically showing an example of a melt extrusion unit that can be used for the manufacturing method of the present invention.

FIG. 3 is an enlarged view of a part A of the melt extrusion unit shown in FIG. 2.

FIG. 4 is a schematic diagram illustrating the size of a pellet to be fed as a material resin to a melt extrusion unit.

FIG. 5 is a cross-sectional view schematically showing an example of a POF manufactured by the manufacturing method of the present invention.

### DESCRIPTION OF EMBODIMENTS

A manufacturing method according to a first aspect of the present invention is a method for manufacturing a plastic optical fiber composed of a plurality of layers including a core and a cladding, the manufacturing method including
forming at least one layer formed of the plurality of layers by melt extrusion molding of a material resin using a melt extrusion unit including an extrusion screw, wherein
a pellet of the material resin is fed to the melt extrusion unit, and
a relation expressed by the following inequality (I) is satisfied by a flight height H_{f} (unit: mm) of the extrusion screw in a feed zone of the melt extrusion unit and a maximum dimension Lₘₐₓ (unit: mm) of the pellet to be fed:

$$0 \leq {H}_{f} - {L}_{max} \leq 3 ; \qquad ( I )$$

and
a volume V (unit: mm³) of the pellet satisfies the following inequality (II):

$$4 < V < 25 . \qquad ( II )$$

According to a second aspect of the present invention, for example, in the manufacturing method according to the first aspect, the extrusion screw is composed of a single screw.

According to a third aspect of the present invention, for example, in the manufacturing method according to the first or second aspect, a relation expressed by the following inequality (III) is satisfied by a channel width S_{L} (unit: mm) of the extrusion screw in the feed zone and the maximum dimension Lₘₐₓ (unit: mm) of the pellet:

$$10 \leq {S}_{L} - {L}_{max} \leq 20 . \qquad ( III )$$

According to a fourth aspect of the present invention, for example, in the manufacturing method according to any one of the first to third aspects, a flight width S_{D} (unit: mm) of the extrusion screw in the feed zone satisfies the following inequality (IV):

$$1.5 \leq {S}_{D} \leq 2.5 . \qquad ( IV )$$

A manufacturing apparatus according to a fifth aspect of the present invention is an apparatus for manufacturing a plastic optical fiber composed of a plurality of layers including a core and a cladding, the manufacturing apparatus including
a melt extrusion unit that forms at least one layer selected from the plurality of layers by melt extrusion molding of a pellet of a material resin, wherein
the melt extrusion unit includes an extrusion screw,
a relation expressed by the following inequality (I) is satisfied by a flight height H_{f} (unit: mm) of the extrusion screw in a feed zone of the melt extrusion unit and a maximum dimension Lₘₐₓ (unit: mm) of the pellet to be fed to the melt extrusion unit:

$$0 \leq {H}_{f} - {L}_{max} \leq 3 ; \qquad ( I )$$

and
a volume V (unit: mm³) of the pellet satisfies the following inequality (II):

$$4 < V < 25 . \qquad ( II )$$

According to a sixth aspect of the present invention, for example, the manufacturing apparatus according to the fifth aspect further includes a material feeder that feeds the pellet satisfying the inequality (II) to the melt extrusion unit.

Embodiments of the present invention will be described hereinafter. The following description is not intended to limit the present invention to a particular embodiment.

### POF Manufacturing Method

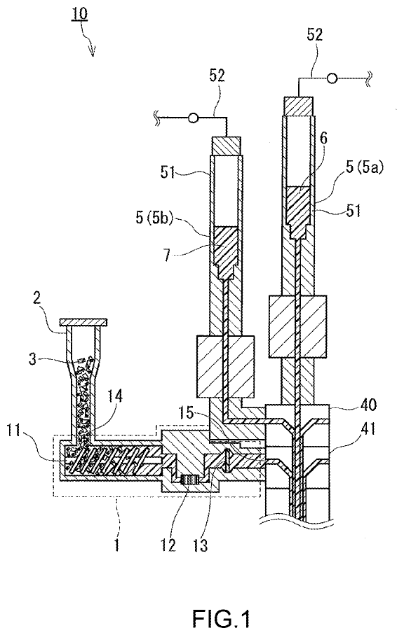

The manufacturing method of the present embodiment will be described with reference to a manufacturing apparatus shown in FIG. 1. A manufacturing apparatus 10 shown in FIG. 1 is a POF manufacturing apparatus. The manufacturing apparatus 10 includes melt extrusion units 1, 5a, and 5b. The melt extrusion unit 1 includes an extrusion screw 11, a gear pump 12, and a polymer filter 13. The extrusion screw 11 of the melt extrusion unit 1 shown in FIG. 1 is composed of a single screw. A hopper (material tank) being a material feeder 2 is connected to an inlet 14 of the melt extrusion unit 1. The hopper contains a pellet of a material resin 3. The material resin 3 is fed from the hopper to the melt extrusion unit 1 and heated to be flowable (softened or molten). The flowable material resin 3 goes through the gear pump 12 and the polymer filter 13 and is then discharged from an outlet 15 of the melt extrusion unit 1 to be a given layer of a POF by melt extrusion molding. The melt extrusion unit 1 utilizes a mechanical pressure generated by the extrusion screw 11. In the melt extrusion unit 1, the extrusion screw 11 may knead the material resin 3. The gear pump 12 is used for controlling the discharge amount of the material resin 3.

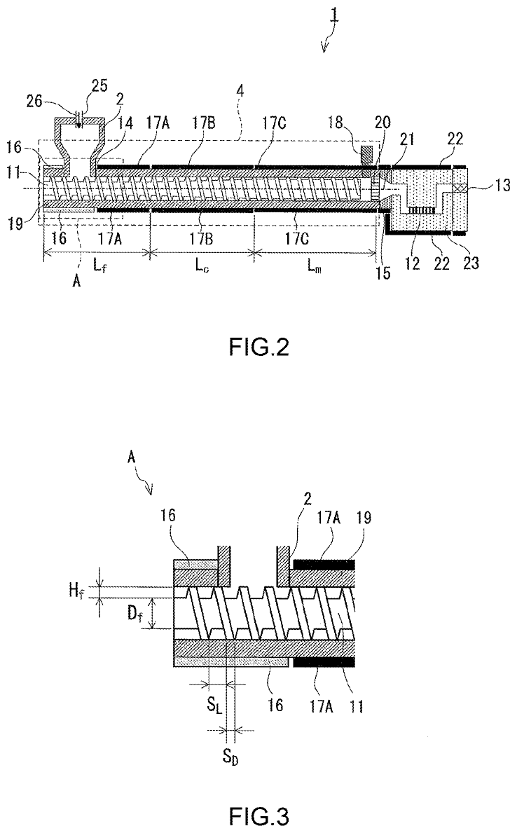

FIG. 2 shows an example of the melt extrusion unit 1 that can be used for the manufacturing method of the present embodiment and the manufacturing apparatus 10. FIG. 3 shows an enlarged view of a part A of the melt extrusion unit 1. As shown in FIG. 2 and FIG. 3, the melt extrusion unit 1 includes an extrusion screw 11 and a screw cylinder 19 including the extrusion screw 11 inside. A single-screw extruder 4 is composed of the extrusion screw 11 and the screw cylinder 19. The melt extrusion unit 1 and the single-screw extruder 4 include the following sections along a flow direction of the material resin 3: a feed zone L_{f}, a compression zone L_{c}; and a metering zone Lₘ. The feed zone L_{f} is a section where the pellet of the material resin 3 fed by the material feeder 2 is conveyed to the compression zone L_{c} and the material resin 3 is preheated. The material resin 3 is in a solid state in the feed zone L_{f}. The compression zone L_{c} is a section where the material resin 3 conveyed from the feed zone L_{f} is heated and compressed to make the material resin 3 flowable. The material resin 3 typically starts to soften or melt at the beginning of the compression zone L_{c}, and becomes completely flowable at the end of the compression zone L_{c}. The metering zone Lₘ is a section where the temperature and the pressure in the flowable material resin 3 are made uniform for stable discharge of the material resin 3. The metering zone Lₘ can also function as a safety section which prevents the material resin 3 remaining solid at the end of the compression zone L_{c}, for example, due to an error of the apparatus from being discharged. In the example shown in FIG. 2, the sections can also be classified by the shape of the extrusion screw 11. In the feed zone L_{f}, a flight height H_{f} and a root diameter D_{f} of the extrusion screw 11 are constant. In the compression zone L_{c}, the flight height H_{f} of the extrusion screw 11 decreases along the flow direction of the material resin 3, while the root diameter D_{f} increases (therefore the material resin 3 can be compressed). The decrease in the flight height H_{f} and the increase in the root diameter D_{f} may be continuous or intermittent. In the metering zone Lₘ, the flight height H_{f} and the root diameter D_{f} of the extrusion screw 11 is again constant. In the example shown in FIG. 2, the screw cylinder 19 has a constant inner diameter throughout the sections.

In the present embodiment, the pellet of the material resin 3 undergo melt extrusion molding using the melt extrusion unit 1 under a condition where the following inequalities (I) and (II) are both satisfied. The symbol H_{f} in the inequality (I) is the flight height (unit: mm) of the extrusion screw 11 in the feed zone L_{f} of the melt extrusion unit 1. The symbol Lₘₐₓ is the maximum dimension (unit: mm) of the pellet of the material resin 3 to be fed to the melt extrusion unit 1. The symbol V in the inequality (II) is the volume (unit: mm³) of the pellet of the material resin 3.

$$0 \leq {H}_{f} - {L}_{max} \leq 3 \qquad ( I )$$

$$4 < V < 25 \qquad ( II )$$

If H_{f}−Lₘₐₓ is less than 0, compression of the pellet of the material resin 3 in the feed zone L_{f} by means of rotation of the extrusion screw 11 is likely to cause adhesion of the pellets of the material resin 3. Adhesion can cause blocking. Blocking can prevent stable discharge of the material resin 3, decreasing the quality of the POF. Furthermore, the discharge amount (per unit time) of the material resin 3 in manufacturing of POFs having a small diameter is much smaller, for example, than in common shaping techniques such as film shaping and injection molding. In other words, the melt extrusion unit 1 is very small in size compared to devices used for common shaping techniques. This means that blocking can have a heavy impact on POF manufacturing; however, occurrence of blocking can be reduced when H_{f}−Lₘₐₓ is 0 or more.

If H_{f}−Lₘₐₓ is more than 3, H_{f} is greater and thus the amount of the material resin 3 discharged by one rotation of the extrusion screw 11 is larger. In this case, in order to manufacture a POF at a small discharge amount per unit time, it is indispensable to control and decrease the rotation speed of the extrusion screw 11. Such control results in variation in the rotation speed of the extrusion screw 11, and the variation prevents stable discharge of the material resin 3. The variation can be suppressed when H_{f}−Lₘₐₓ is 3 or less.

If V is 4 or less, the surface area of the pellet per unit volume increases and thus blocking is likely to occur. Additionally, if V is 4 or less, the pellet is prone to absorb moisture in the hopper, so that a decrease in strength, inclusion of bubbles, or the like will be likely to happen as a result of hydrolysis during melt molding. Another possibility is that static adsorption to a wall of the hopper makes feeding to the melt extrusion unit 1 unstable. Occurrence of these problems can be reduced when V is more than 4.

If V is 25 or more, Lₘₐₓ is greater and thus increase in H_{f} is unavoidable to satisfy the inequality (I). Occurrence of the above problems due to increase in H_{f} can be reduced when V is less than 25.

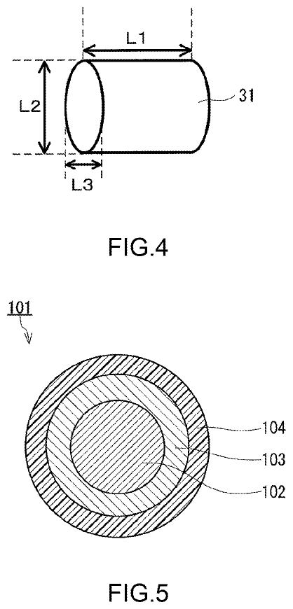

The maximum dimension Lₘₐₓ and the volume V of the pellet can be evaluated, for example, by image processing. Specifically, at least 50 pellets are taken out of 1 kg of the pellet, and each is evaluated for its maximum dimension and its volume. The average of the maximum dimensions and that of the volumes are respectively defined as the maximum dimension Lₘₐₓ and the volume V. In the case that the pellet (in a cylindrical or elliptic cylindrical shape) is produced by cutting a strand having a circular or elliptic cross-section, the maximum dimension Lₘₐₓ and the volume V may be determined by the following method. At least fifty pellets 31 are taken out of 1 kg of the pellet, and each pellet 31 is evaluated for a height L1, a major axis L2 of an end face, and a minor axis L3 of the end face (refer to FIG. 4; the unit of each is millimeter). A caliper can be used for evaluation of L1, L2, and L3. A larger value was selected from the height L1 and the major axis L2 for each pellet 31, and the average of the selected values of the pellets 31 is defined as the maximum dimension Lₘₐₓ. Moreover, the average of the volumes determined for the pellets 31 by the following equation (5) is defined as the volume V.

$$Volume ( {mm}^{3} ) = ( L 1 \times L 2 \times L 3 ) \times π / 4 \qquad ( 5 )$$

The lower limit of H_{f}−Lₘₐₓ may be 0.1 or more, 0.3 or more, or even 0.5 or more. The upper limit of H_{f}−Lₘₐₓ may be 2.7 or less, 2.5 or less, 2.2 or less, or even 2 or less.

The upper limit of V may be 24 or less, 22 or less, or even 20 or less.

Additional members shown in FIG. 2 and FIG. 3 and their functions will be described. A reference character 16 indicates a cooling block disposed on an outer wall of the screw cylinder 19 in the vicinity of a connecting portion in the feed zone L_{f} and the inlet 14, the connecting portion being connected to the material feeder 2. The cooling block 16 prevents transmission of heat in the feed zone L_{f}, which serves also as a section for preheating the material resin 3, to the material feeder 2. A reference character 17A indicates a band heater disposed on the outer wall of the screw cylinder 19 downstream of the connecting portion in the feed zone L_{f} and the inlet 14. The band heater 17A can be used to preheat the material resin 3 in the feed zone L_{f}. Reference characters 17B and 17C indicate band heaters disposed on the outer wall of the screw cylinder 19 in the compression zone L_{c} and the metering zone Lₘ respectively. The band heaters 17B and 17C can be used to adjust the temperature of the material resin 3 at given temperatures in the compression zone L_{c} and the metering zone Lₘ respectively. A reference character 18 indicates a screw head pressure gauge that can be used to measure a pressure at which the material resin 3 is discharged. A reference character 20 indicates a breaker plate that prevents the material resin 3 in a solid state from being mistakenly discharged. A reference character 21 indicates a pipe through which the material resin 3 discharged from the outlet 15 flows. The gear pump 12 and the polymer filter 13 are disposed in the course of the pipe 21. A band heater 22 for adjusting the temperature of the material resin 3 at a given temperature is disposed on an outer wall of a block 23 provided with the pipe 21, the material resin 3 flowing through the pipe 21. A reference character 25 indicates a pipe that leads a gas 26 into the material feeder 2. For example, the pipe may lead a dry gas into the material feeder 2 to dry the material resin 3 therein. The dry gas is, for example, a dry nitrogen gas. Known members can be used as these additional members.

The melt extrusion unit 5 (5a, 5b) includes a container 51. The container 51 of the melt extrusion unit 5a contains a material resin 6 in a molten state. The container 51 of the melt extrusion unit 5b contains a material resin 7 in a molten state. To the melt extrusion unit 5 is connected a gas supply line 52 that applies a gas pressure to the material resin 6 or 7, and the material resin 6 or 7 discharged by the gas pressure undergoes melt extrusion molding to form a given layer of a POF. The melt extrusion unit 5 is a melt extrusion unit using a gas pressure.

A POF 101 (refer to FIG. 5) composed of three layers, namely, a core 102, a cladding 103, and a coating layer 104, can be manufactured using the manufacturing apparatus 10. The POF 101 is typically a graded-index (GI) POF. However, the type of the POF 101 is not limited to the GI type. The core 102, the cladding 103, and the coating layer 104 are formed by melt extrusion molding using the melt extrusion units 5a, 5b, and 1, respectively. The cladding 103 is formed by molding the material resin 7 discharged from the melt extrusion unit 5b in a first chamber 40 to coat the outer circumference of the core 102. The coating layer 104 is formed by molding the material resin 3 discharged from the melt extrusion unit 1 in a second chamber 41 to coat the outer circumference of the cladding 103. Persons skilled in the art would call the coating layer 104 an overcladding. The first chamber 40 and the second chamber 41 are vertically arranged in this order from top to bottom. The cladding 103 and the coating layer 104 are formed in this order while the core 102 formed by melt extrusion molding using the melt extrusion unit 5a is passing the first chamber 40 and then the second chamber 41. In the example shown in FIG. 1, the coating layer 104 is formed by melt extrusion molding using the melt extrusion unit 1, the melt extrusion molding satisfying the above inequalities (I) and (II). However, a layer formed by this molding is not limited to the coating layer 104. In the present embodiment, at least one layer selected from a plurality of layers composing a POF can be formed by the above molding.

A melt extrusion unit suitable for formation of a desired layer may be selected from the following viewpoints. The melt extrusion unit 5 using a gas pressure can more efficiently reduce inclusion of impurities (e.g., metal) into a layer to be formed than the melt extrusion unit 1 using a mechanical pressure. Inclusion of metal can deteriorate optical properties of a layer to be formed and the POF 101 including the layer even if the amount of the metal included therein is very small (e.g., on the order of ppm). On the other hand, the melt extrusion unit 1 using a mechanical pressure can reduce a layer molding cost compared to the melt extrusion unit 5 using a gas pressure. From this point of view, as in the example of FIG. 1, the core 102 and the cladding 103 that transmit most of light may be formed with the melt extrusion unit 5, while the coating layer 104 that rarely transmits light may be formed with the melt extrusion unit 1. It should be noted that the melt extrusion unit 1 typically does not use a gas pressure for melt extrusion.

A molding temperature of the material resin during melt extrusion molding in the melt extrusion unit 1 and/or the melt extrusion unit 5 may be the glass transition temperature (Tg) of the material resin plus 100° C. or higher, or Tg plus 120° C. or higher. The upper limit of the molding temperature is, for example, Tg plus 180° C. or lower. When the molding temperature is in the above range, for example, a volatile component in the material resin is more reliably removed during molding. Removal of the volatile component contributes to further improvement of the quality of the POF 101.

The melt extrusion unit 1 shown in FIG. 1 includes the extrusion screw 11 composed of a single screw. The melt extrusion unit 1 may include the extrusion screw 11 composed of multiple screws, more specifically, may include a multi-screw extruder. When the melt extrusion unit 1 includes the extrusion screw 11 composed of multiple screws, the inequality (I) may be satisfied by at least one screw of the extrusion screw 11 and the pellet of the material resin 3. The inequality (I) may be satisfied by every screw of the extrusion screw 11 and the pellet of the material resin 3.

A relation expressed by the following inequality (III) may be satisfied by a channel width S_{L} (unit: mm) (refer to FIG. 3) of the extrusion screw 11 in the feed zone L_{f} and the maximum dimension Lₘₐₓ (unit: mm) of the pellet of the material resin 3. When the inequality (III) is satisfied, occurrence of blocking can be more reliably reduced. Moreover, when the inequality (III) is satisfied, the amount of the material resin 3 discharged during one rotation of the extrusion screw 11 is not too large and thus the stability of discharge is improved.

$$10 \leq {S}_{L} - {L}_{max} \leq 20 \qquad ( III )$$

The lower limit of S_{L}−Lₘₐₓ may be 11 or more, 12 or more, or even 14 or more. The upper limit of S_{L}−Lₘₐₓ may be 19 or less, 18 or less, or even 16 or less.

When the melt extrusion unit 1 includes the extrusion screw 11 composed of multiple screws, the inequality (III) may be satisfied by at least one screw of the extrusion screw 11 and the pellet of the material resin 3, or the inequality (III) may be satisfied by every extrusion screw 11 and the pellet of the material resin 3.

A flight width S_{D} (unit: mm) (refer to FIG. 3) of the extrusion screw 11 in the feed zone L_{f} may satisfy the following inequality (IV). When the inequality (IV) is satisfied, both the mechanical strength of the extrusion screw 11 and a volumetric capacity of a space for the material resin 3 in the entire feed zone L_{f} can be ensured. Ensuring the volumetric capacity contributes to stable discharge of the material resin 3.

$$1.5 \leq {S}_{D} \leq 2.5 \qquad ( IV )$$

When the melt extrusion unit 1 includes the extrusion screw 11 composed of multiple screws, at least one screw of the extrusion screw 11 may satisfy the inequality (IV), or every screw of the extrusion screw 11 may satisfy the inequality (IV).

### Material Resin

For the core 102 and the cladding 103, examples of the material resin include fluorine-containing resins, acrylic resins such as methyl methacrylate, styrene resins, and carbonate resins. The refractive index of the material resin of the cladding 103 is commonly smaller than that of the material resin of the core 102. For the coating layer 104, examples of the material resin include polycarbonates, various engineering plastics, cycloolefin polymers, polytetrafluoroethylene (PTFE), modified PTFEs, and perfluoroalkoxy alkanes (PFA). The material resin may include an additive such as a refractive index modifier. The material resin is not limited to the above examples. Known resins that can be included in layers of a POF may be selected as the material resin.

The material resin may be hydrolyzable. The hydrolyzable resin includes, for example, at least one structure selected from the group consisting of an ester structure, a carbonate structure, a urethane structure, an amide structure, an ether structure, a urethane structure, and an acetal structure. The hydrolyzable resin is, for example, a polycarbonate. A polycarbonate is included, for example, in the coating layer 104. When the material resin 3 is hydrolyzable, a dry gas may flow into the material feeder 2 to dry the material resin 3 in the material feeder 2.

An example of a fluorine-containing resin (a polymer (P)) will be described hereinafter. The polymer (P) described hereinafter is suitable for being included in the core 102. It is preferred that the polymer (P) be substantially free of a hydrogen atom from the viewpoint of reducing light absorption attributable to stretching energy of a C—H bond. It is particularly preferred that every hydrogen atom bonded to a carbon atom be substituted by a fluorine atom. Herein, saying that the polymer (P) is substantially free of a hydrogen atom means that the hydrogen atom content in the polymer (P) is 1 mol % or less.

The polymer (P) preferably has a fluorine-containing aliphatic ring structure. The fluorine-containing aliphatic ring structure may be included in a main chain of the polymer (P), or may be included in a side chain of the polymer (P). The polymer (P) has, for example, a structural unit (A) represented by the following formula (1).

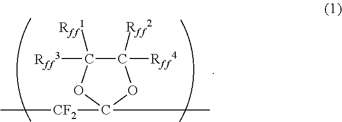

In the formula (1), R_{ff}¹ to R_{ff}⁴ each independently represent a fluorine atom, a perfluoroalkyl group having 1 to 7 carbon atoms, or a perfluoroalkyl ether group having 1 to 7 carbon atoms. R_{ff}¹ and R_{ff}² may be linked to form a ring. “Perfluoro” indicates that every hydrogen atom bonded to a carbon atom is substituted by a fluorine atom. In the formula (1), the number of carbon atoms in the perfluoroalkyl group is preferably 1 to 5, more preferably 1 to 3, and even more preferably 1. The perfluoroalkyl group may be linear or branched. Examples of the perfluoroalkyl group include a trifluoromethyl group, a pentafluoroethyl group, and a heptafluoropropyl group.

In the formula (1), the number of carbon atoms in the perfluoroalkyl ether group is preferably 1 to 5 and more preferably 1 to 3. The perfluoroalkyl ether group may be linear or branched. Examples of the perfluoroalkyl ether group include a perfluoromethoxymethyl group.

In the case where R_{ff}¹ and R_{ff}² are linked to form a ring, the ring may be a five-membered ring or a six-membered ring. Examples of the ring include a perfluorotetrahydrofuran ring, a perfluorocyclopentane ring, and a perfluorocyclohexane ring.

Specific examples of the structural unit (A) include structural units represented by the following formulae (A1) to (A8).

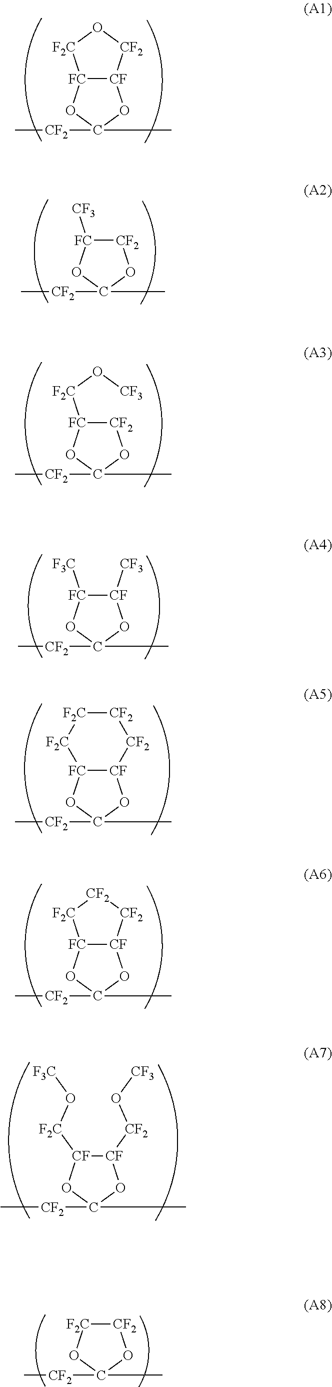

Among the structural units represented by the above formulae (A1) to (A8), the structural unit (A) is preferably the structural unit (A2), i.e., a structural unit represented by the following formula (2).

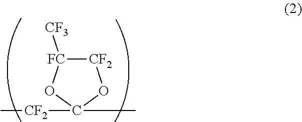

The polymer (P) may include one or more structural units (A). In the polymer (P), the amount of the structural unit (A) is preferably 20 mol % or more and more preferably 40 mol % or more of a total amount of all structural units. When including 20 mol % or more of the structural unit (A), the polymer (P) tends to have much higher thermal resistance. When including 40 mol % or more of the structural unit (A), the polymer (P) tends to have much higher transparency and much higher mechanical strength in addition to high thermal resistance. In the polymer (P), the amount of the structural unit (A) is preferably 95 mol % or less and more preferably 70 mol % or less of the total amount of all structural units.

The structural unit (A) is derived from, for example, a compound represented by the following formula (3). In the formula (3), R_{ff}¹ to R_{ff}⁴ are as described in the formula (1). It should be noted that the compound represented by the formula (3) can be obtained, for example, by an already-known manufacturing method such as a manufacturing method disclosed in JP 2007-504125 A.

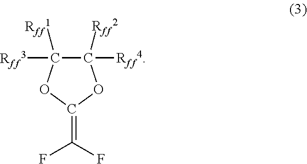

Specific examples of the compound represented by the above formula (3) include compounds represented by the following formulae (M1) to (M8).

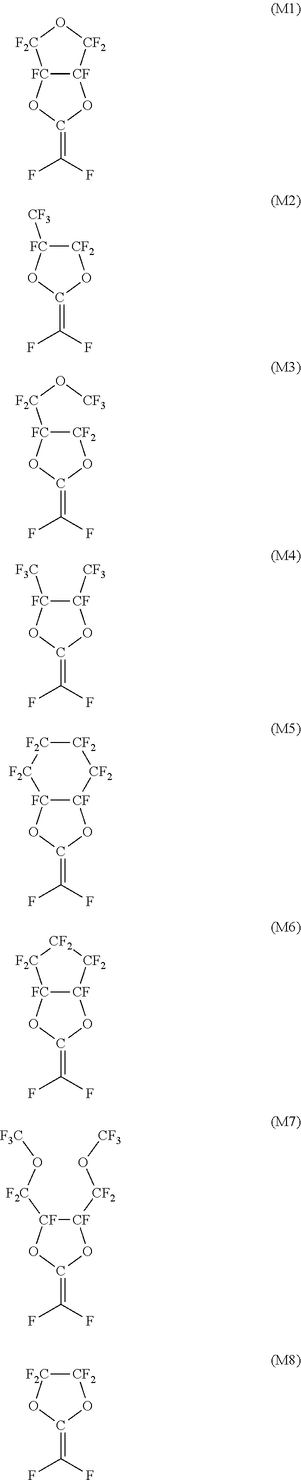

The polymer (P) may further include an additional structural unit other than the structural unit (A). Examples of the additional structural unit include the following structural units (B) to (D).

The structural unit (B) is represented by the following formula (4).

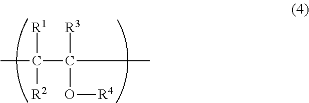

In the formula (4), R¹ to R³ each independently represent a fluorine atom or a perfluoroalkyl group having 1 to 7 carbon atoms. R⁴ represents a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The polymer (P) may include one or more structural units (B). In the polymer (P), the amount of the structural unit (B) is preferably 5 to 10 mol % of the total amount of all structural units. The amount of the structural unit (B) may be 9 mol % or less or 8 mol % or less.

The structural unit (B) is derived from, for example, a compound represented by the following formula (5). In the formula (5), R¹ to R⁴ are as described for the formula (4). The compound represented by the formula (5) is a fluorine-containing vinyl ether such as perfluorovinyl ether.

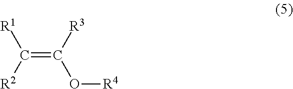

The structural unit (C) is represented by the following formula (6).

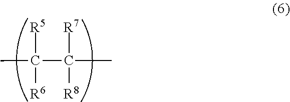

In the formula (6), R⁵ to R⁸ each independently represent a fluorine atom or a perfluoroalkyl group having 1 to 7 carbon atoms. The perfluoroalkyl group may have a ring structure. One or some of the fluorine atoms may be substituted by a halogen atom other than a fluorine atom. One or some of fluorine atoms in the perfluoroalkyl group may be substituted by a halogen atom other than a fluorine atom.

The polymer (P) may include one or more structural units (C). In the polymer (P), the amount of the structural unit (C) is preferably 5 to 10 mol % of the total amount of all structural units. The amount of the structural unit (C) may be 9 mol % or less or 8 mol % or less.

The structural unit (C) is derived from, for example, a compound represented by the following formula (7). In the formula (7), R⁵ to R⁸ are as described for the formula (6). The compound represented by the formula (7) is a fluorine-containing olefin such as tetrafluoroethylene or chlorotrifluoroethylene.

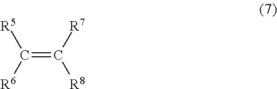

The structural unit (D) is represented by the following formula (8).

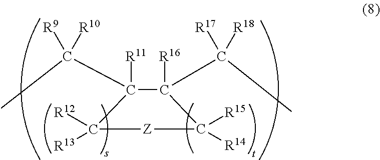

In the formula (8), Z represents an oxygen atom, a single bond, or —OC(R¹⁹R²⁰)O—, R⁹ to R²⁰ each independently represent a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom. Symbols s and t are each independently 0 to 5, and s+t is an integer of 1 to 6 (when Z is —OC(R¹⁹R²⁰)O—, s+t may be 0).

The structural unit (D) is preferably represented by the following formula (9). The structural unit represented by the following formula (9) is a structural unit represented by the above formula (8), where Z is an oxygen atom, s is 0, and t is 2.

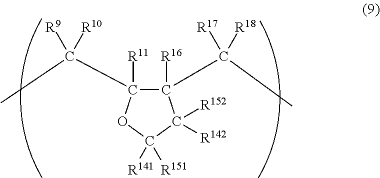

In the formula (9), R¹⁴¹, R¹⁴², R¹⁵¹, and R¹⁵² are each independently a fluorine atom, a perfluoroalkyl group having 1 to 5 carbon atoms, or a perfluoroalkoxy group having 1 to 5 carbon atoms. One or some of the fluorine atoms may be substituted by a halogen atom other than a fluorine atom. One or some of fluorine atoms in the perfluoroalkyl group may be substituted by a halogen atom other than a fluorine atom. One or some of fluorine atoms in the perfluoroalkoxy group may be substituted by a halogen atom other than a fluorine atom.

The polymer (P) may include one or more structural units (D). In the polymer (P), the amount of the structural unit (D) is preferably 30 to 67 mol % of the total amount of all structural units. The amount of the structural unit (D) is, for example, 35 mol % or more, and may be 60 mol % or less or 55 mol % or less.

The structural unit (D) is, for example, derived from a compound represented by the following formula (10). In the formula (10), Z, R⁹ to R¹⁸, s, and t are as described for the formula (8). The compound represented by the formula (10) is a cyclopolymerizable fluorine-containing compound having two or more polymerizable double bonds.

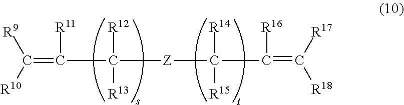

The structural unit (D) is preferably derived from a compound represented by the following formula (11). In the formula (11), R¹⁴¹, R¹⁴², R¹⁵¹, and R¹⁵² are as described for the formula (9).

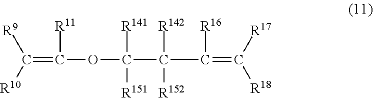

Specific examples of the compound represented by the formula (10) or the formula (11) include the following compounds.
CF₂═CFOCF₂CF═CF₂
CF₂═CFOCF(CF₃)CF═CF₂
CF₂═CFOCF₂CF₂CF═CF₂
CF₂═CFOCF₂CF(CF₃)CF═CF₂
CF₂═CFOCF(CF₃)CF₂CF═CF₂
CF₂═CFOCFClCF₂CF═CF₂
CF₂═CFOCCl₂CF₂CF═CF₂
CF₂═CFOCF₂OCF═CF₂
CF₂═CFOC(CF₃)₂OCF═CF₂
CF₂═CFOCF₂CF(OCF₃)CF═CF₂
CF₂═CFCF₂CF═CF₂
CF₂═CFCF₂CF₂CF═CF₂
CF₂═CFCF₂OCF₂CF═CF₂
CF₂═CFOCF₂CFClCF═CF₂
CF₂═CFOCF₂CF₂CCl═CF₂
CF₂═CFOCF₂CF₂CF═CFCl
CF₂═CFOCF₂CF(CF₃)CCl═CF₂
CF₂═CFOCF₂OCF═CF₂
CF₂═CFOCCl₂OCF═CF₂
CF₂═CClOCF₂OCCl═CF₂

The polymer (P) may further include an additional structural unit other than the structural units (A) to (D). However, the polymer (P) is preferably substantially free of an additional structural unit other than the structural units (A) to (D). Saying that the polymer (P) is substantially free of an additional structural unit other than the structural units (A) to (D) means that the sum of the amounts of the structural units (A) to (D) is 95 mol % or more and preferably 98 mol % or more of the total amount of all structural units in the polymer (P).

The method for polymerizing the polymer (P) is not limited to a particular one, and a common polymerization method such as radical polymerization can be used. A polymerization initiator for the polymerization of the polymer (P) may be a fully-fluorinated compound.

The glass transition temperature (Tg) of the polymer (P) is, for example, but not particularly limited to, 100° C. to 140° C., and may be 105° C. or higher or 120° C. or higher. The term “Tg” herein refers to a midpoint glass transition temperature (T_{mg}) determined according to Japanese Industrial Standards (JIS) K 7121:1987.

### Manufacturing Apparatus

The manufacturing apparatus 10 shown in FIG. 1 is an apparatus for manufacturing a POF composed of a plurality of layers including a core and a cladding, can be used for the manufacturing method of the present embodiment, and is also an example of the manufacturing apparatus of the present embodiment.

The manufacturing apparatus 10 may include the material feeder 2 that feeds a pellet satisfying the above inequality (II) (4<V<25) to the melt extrusion unit 1.

The manufacturing apparatus 10 may further include a control unit (not illustrated). The control unit includes, for example, a digital signal processor (DSP) including an A/D conversion circuit, an input/output circuit, a computing circuit, a memory device, etc. A program for properly operating the manufacturing apparatus 10 may be stored in the control unit. For example, the melt extrusion unit 1 can be controlled by the control unit. The flow rate of the dry gas that flows into the material feeder 2 may be controlled by the control unit. The manufacturing apparatus 10 may include a hygrometer that measures the absolute humidity of the atmosphere in the material feeder 2. The control unit and the hygrometer may be connected to each other.

### POF

For example, the POF 101 shown in FIG. 5 can be manufactured by the manufacturing method or with the manufacturing apparatus according to the present invention. However, a POF manufactured thereby or therewith is not limited to the example shown in FIG. 5.

### EXAMPLES

The present invention will be described in more detail with reference to examples. The present invention is not limited to the examples given below.

### Example 1

The maximum dimension Lₘₐₓ and the volume V of a pellet of a polycarbonate resin (manufactured by Mitsubishi Chemical Corporation; model number: DURABIO) were evaluated by the above method (note that the averages were determined using five pellets 31), which is an evaluation method for the pellet 31 in an elliptic cylindrical shape. The pellet had dimensions of L1=2.9 mm, L2=3.2 mm, and L3=2.5 mm. The maximum dimension Lₘₐₓ was 3.2 mm, and the volume V was 18.22 mm³.

Next, 1 kg of the above pellet was dried in an oven at 100° C. for six hours, and was added as the material resin 3 into a hopper connected to the melt extrusion unit 1 shown in FIG. 2. During a melt extrusion test described below, a dry nitrogen gas was allowed to continuously flow into the hopper at a flow rate of 20 L/minute. Of the feed zone L_{f} of the extrusion screw 11, the flight height H_{f} was 3.9 mm, the root diameter D_{f} was 12.0 mm, the channel width S_{L} was 18.0 mm, and the flight width S_{D} was 2.0 mm. Moreover, as of the lengths of the sections of the melt extrusion unit 1 (the single-screw extruder 4), the feed zone L_{f} was 200 mm, the compression zone L_{c} was 160 mm, the metering zone Lₘ was 215 mm.

Subsequently, discharge of the resin in a molten state from the melt extrusion unit 1 was started under conditions that the rotation speed of the gear pump 12 (discharge capability: 1.2 mL/rotation) was set and fixed to 2.8 rpm and the rotation speed of the extrusion screw 11 was controlled such that a screw head pressure value measured by the pressure gauge 18 was 3 MPa. After the unit 1 was operated for two straight hours in a row to charge a flow path inside the unit 1 with the molten resin, the weight (a discharge weight per 36 seconds) of the molten resin discharged from the outlet 15 was started to be measured. The measurement was performed five times in total at an interval of 10 minutes. A measurement value for each time was converted into the discharge amount (unit: mL/hour) per unit time. The average (Ave) of the discharge amounts and 3σ/Ave thereof were calculated. Furthermore, the screw head pressure and the rotation speed of the extrusion screw 11 were measured for 30 minutes at 0.1-second intervals. The averages (Ave) thereof and rates 3σ/Ave thereof were calculated. Next, the unit 1 was stopped after the unit 1 was operated for three straight hours in a row from the start of the discharge. The inside of the feed zone L_{f} was visually examined to see whether blocking occurred. The discharge stability in the melt extrusion test was evaluated by the calculation of 3σ/Ave which corresponds to variations in discharge and the examination of whether blocking occurred in the feed zone L_{f}.

### Example 2

The discharge stability was evaluated in the same manner as in Example 1, except that the rotation speed of the gear pump 12 was set and fixed to 16.7 rpm.

### Example 3

The discharge stability was evaluated in the same manner as in Example 1, except that the pellet of the material resin 3 was processed to have dimensions of L1=3.0 mm, L2=2.8 mm, and L3=1.8 mm (maximum dimension Lₘₐₓ=3.0 mm, volume V=11.88 mm³).

### Example 4

The discharge stability was evaluated in the same manner as in Example 3, except that the rotation speed of the gear pump 12 was set and fixed to 16.7 rpm.

### Example 5

The discharge stability was evaluated in the same manner as in Example 1, except that the pellet of the material resin 3 was processed to have dimensions of L1=2.0 mm, L2=2.1 mm, and L3=1.5 mm (maximum dimension Lₘₐₓ=2.1 mm, volume V=4.95 mm³).

### Example 6

The discharge stability was evaluated in the same manner as in Example 5, except that the rotation speed of the gear pump 12 was set and fixed to 16.7 rpm.

### Comparative Example 1

The discharge stability was evaluated in the same manner as in Example 1, except that of the feed zone L_{f} of the extrusion screw 11, the flight height H_{f} was 2.2 mm, the root diameter D_{f} was 7.5 mm, the channel width S_{L} was 12.0 mm, and the flight width S_{D} was 2.8 mm and that as of the lengths of the sections of the melt extrusion unit 1, the feed zone L_{f} was 96 mm, the compression zone Le was 96 mm, and the metering zone Lₘ was 296 mm.

### Comparative Example 2

The discharge stability was evaluated in the same manner as in Comparative Example 1, except that the rotation speed of the gear pump 12 was set and fixed to 16.7 rpm.

### Comparative Example 3

The discharge stability was evaluated in the same manner as in Comparative Example 1, except that the pellet of the material resin 3 was processed to have dimensions of L1=3.0 mm, L2=2.8 mm, and L3=1.8 mm (maximum dimension Lₘₐₓ=3.0 mm, volume V=11.88 mm³).

### Comparative Example 4

The discharge stability was evaluated in the same manner as in Comparative Example 3, except that the rotation speed of the gear pump 12 was set and fixed to 16.7 rpm.

### Comparative Example 5

The discharge stability was evaluated in the same manner as in Example 1, except that the pellet of the material resin 3 was processed to have dimensions of L1=1.0 mm, L2=2.1 mm, and L3=1.5 mm (maximum dimension Lₘₐₓ=2.1 mm, volume V=2.47 mm³).

### Comparative Example 6

The discharge stability was evaluated in the same manner as in Comparative Example 5, except that the rotation speed of the gear pump 12 was set and fixed to 16.7 rpm.

### Comparative Example 7

The discharge stability was evaluated in the same manner as in Comparative Example 1, except that the pellet of the material resin 3 was processed to have dimensions of L1=1.0 mm, L2=2.1 mm, and L3=1.5 mm (maximum dimension Lₘₐₓ=2.1 mm, volume V=2.47 mm³).

### Comparative Example 8

The discharge stability was evaluated in the same manner as in Comparative Example 7, except that the rotation speed of the gear pump 12 was set and fixed to 16.7 rpm.

Tables 1 and 2 below show the conditions of the melt extrusion test and the evaluation results.

TABLE 1

| | | Pellet | | | | | Melt extrusion unit | | | | | | Gear pump |
|---|---|---|---|---|---|---|---|---|---|---|---|---|---|
| | | Dimensions | | | | Volume | Feed zone | | | | H_{f} − | S_{L} − | rotation |
| | | (mm) | | | | (mm³) | H_{f} | D_{f} | S_{L} | S_{D} | Lₘₐₓ | Lₘₐₓ | speed |
| | | L1 | L2 | L3 | Lₘₐₓ | V | (mm) | (mm) | (mm) | (mm) | (mm) | (mm) | (rpm) |
| Example | 1 | 2.9 | 3.2 | 2.5 | 3.2 | 18.22 | 3.9 | 12.0 | 18.0 | 2.0 | 0.7 | 14.8 | 2.8 |
| | 2 | 2.9 | 3.2 | 2.5 | 3.2 | 18.22 | 3.9 | 12.0 | 18.0 | 2.0 | 0.7 | 14.8 | 16.7 |
| | 3 | 3.0 | 2.8 | 1.8 | 3.0 | 11.88 | 3.9 | 12.0 | 18.0 | 2.0 | 0.9 | 15.0 | 2.8 |
| | 4 | 3.0 | 2.8 | 1.8 | 3.0 | 11.88 | 3.9 | 12.0 | 18.0 | 2.0 | 0.9 | 15.0 | 16.7 |
| | 5 | 2.0 | 2.1 | 1.5 | 2.1 | 4.95 | 3.9 | 12.0 | 18.0 | 2.0 | 1.8 | 15.9 | 2.8 |
| | 6 | 2.0 | 2.1 | 1.5 | 2.1 | 4.95 | 3.9 | 12.0 | 18.0 | 2.0 | 1.8 | 15.9 | 16.7 |
| Comparative | 1 | 2.9 | 3.2 | 2.5 | 3.2 | 18.22 | 2.2 | 7.5 | 12.0 | 2.8 | −1.0 | 8.8 | 2.8 |
| Example | 2 | 2.9 | 3.2 | 2.5 | 3.2 | 18.22 | 2.2 | 7.5 | 12.0 | 2.8 | −1.0 | 8.8 | 16.7 |
| | 3 | 3.0 | 2.8 | 1.8 | 3.0 | 11.88 | 2.2 | 7.5 | 12.0 | 2.8 | −0.8 | 9.0 | 2.8 |
| | 4 | 3.0 | 2.8 | 1.8 | 3.0 | 11.88 | 2.2 | 7.5 | 12.0 | 2.8 | −0.8 | 9.0 | 16.7 |
| | 5 | 1.0 | 2.1 | 1.5 | 2.1 | 2.47 | 3.9 | 12.0 | 18.0 | 2.0 | 1.8 | 15.9 | 2.8 |
| | 6 | 1.0 | 2.1 | 1.5 | 2.1 | 2.47 | 3.9 | 12.0 | 18.0 | 2.0 | 1.8 | 15.9 | 16.7 |
| | 7 | 1.0 | 2.1 | 1.5 | 2.1 | 2.47 | 2.2 | 7.5 | 12.0 | 2.8 | 0.1 | 9.9 | 2.8 |
| | 8 | 1.0 | 2.1 | 1.5 | 2.1 | 2.47 | 2.2 | 7.5 | 12.0 | 2.8 | 0.1 | 9.9 | 16.7 |

TABLE 2

| | | Discharge amount of | | Rotation speed of | | Screw head | | |
|---|---|---|---|---|---|---|---|---|
| | | resin | | extrusion screw | | pressure | | |
| | | Ave | 3σ/Ave | Ave | 3σ/Ave | Ave | 3σ/Ave | Blocking in |
| | | (mL/hour) | (%) | (rpm) | (%) | (MPa) | (%) | feed zone L_{f} |
| Example | 1 | 179.9 | 1.4 | 4.8 | 10.50 | 3.1 | 8.3 | Not blocked |
| | 2 | 1074.7 | 1.2 | 31.9 | 5.41 | 3.1 | 7.3 | Not blocked |
| | 3 | 180.3 | 1.3 | 4.7 | 9.81 | 3.0 | 7.5 | Not blocked |
| | 4 | 1079.9 | 1.2 | 32.0 | 5.39 | 3.0 | 6.8 | Not blocked |
| | 5 | 182.3 | 1.2 | 5.0 | 11.30 | 3.0 | 7.3 | Not blocked |
| | 6 | 1081.2 | 1.2 | 31.2 | 5.56 | 3.0 | 6.7 | Not blocked |
| Comparative | 1 | 176.3 | 5.6 | 6.5 | 22.50 | 2.6 | 20.2 | Blocked |
| Example | 2 | 1068.7 | 12.3 | 36.2 | 36.20 | 1.9 | 49.2 | Blocked |
| | 3 | 179.3 | 3.2 | 6.2 | 12.40 | 2.7 | 20.1 | Blocked |
| | 4 | 1073.2 | 7.7 | 33.6 | 28.90 | 2.4 | 30.2 | Blocked |
| | 5 | 180.3 | 3.1 | 5.8 | 14.70 | 2.5 | 19.3 | Blocked |
| | 6 | 1079.9 | 5.6 | 33.8 | 26.34 | 2.9 | 21.9 | Blocked |
| | 7 | 178.2 | 3.6 | 4.8 | 15.73 | 2.3 | 18.2 | Blocked |
| | 8 | 1059.2 | 8.2 | 36.6 | 40.34 | 2.1 | 33.4 | Blocked |

As shown in Tables 1 and 2, Examples 1 to 6 in which the above inequalities (I) and (II) are satisfied exhibit improved discharge stability compared to Comparative Examples.

### INDUSTRIAL APPLICABILITY

The manufacturing method and the manufacturing apparatus according to the present invention can be used for POF manufacturing.

1. A method for manufacturing a plastic optical fiber composed of a plurality of layers including a core and a cladding, the manufacturing method comprising
forming at least one layer selected from the plurality of layers by melt extrusion molding of a material resin using a melt extrusion unit including an extrusion screw, wherein
a pellet of the material resin is fed to the melt extrusion unit, and
a relation expressed by the following inequality (I) is satisfied by a flight height H_{f} (unit: mm) of the extrusion screw in a feed zone of the melt extrusion unit and a maximum dimension Lₘₐₓ (unit: mm) of the pellet to be fed:
$$0 \leq {H}_{f} - {L}_{max} \leq 3 ; \qquad ( I )$$
and
a volume V (unit: mm³) of the pellet satisfies the following inequality (II):
$$4 < V < 25 . \qquad ( II )$$

2. The manufacturing method according to claim 1, wherein the extrusion screw is composed of a single screw.

3. The manufacturing method according to claim 1, wherein a relation expressed by the following inequality (III) is satisfied by a channel width S_{L} (unit: mm) of the extrusion screw in the feed zone and the maximum dimension Lₘₐₓ (unit: mm) of the pellet:
$$10 \leq {S}_{L} - {L}_{max} \leq 20 . \qquad ( III )$$

4. The manufacturing method according to claim 1, wherein a flight width S_{D} (unit: mm) of the extrusion screw in the feed zone satisfies the following inequality (IV):
$$1.5 \leq {S}_{D} \leq 2.5 . \qquad ( IV )$$

5. An apparatus for manufacturing a plastic optical fiber composed of a plurality of layers including a core and a cladding, the manufacturing apparatus comprising
a melt extrusion unit that forms at least one layer selected from the plurality of layers by melt extrusion molding of a pellet of a material resin, wherein
the melt extrusion unit includes an extrusion screw,
a relation expressed by the following inequality (I) is satisfied by a flight height H_{f} (unit: mm) of the extrusion screw in a feed zone of the melt extrusion unit and a maximum dimension Lₘₐₓ (unit: mm) of the pellet to be fed to the melt extrusion unit:
$$0 \leq {H}_{f} - {L}_{max} \leq 3 ; \qquad ( I )$$
and
a volume V (unit: mm³) of the pellet satisfies the following inequality (II):
$$4 < V < 25 . \qquad ( II )$$

6. The manufacturing apparatus according to claim 5, further comprising a material feeder that feeds the pellet satisfying the inequality (II) to the melt extrusion unit.
